(19) United States
(12) Patent Application Publication
(10) Pub. No.: US 2015/0185456 A1
(43) Pub. Date: Jul. 2, 2015

(54) MICROSCOPE SYSTEM AND CONTROL METHOD THEREFOR

(71) Applicant: Sony Corporation, Tokyo (JP)

(72) Inventor: Koichiro Kishima, Kanagawa (JP)

(73) Assignee: Sony Corporation, Tokyo (JP)

(21) Appl. No.: 14/576,948

(22) Filed: Dec. 19, 2014

(30) Foreign Application Priority Data
Dec. 27, 2013 (JP) 2013-272795

(51) Int. Cl. G02B 21/00; H04N 5/225

(52) U.S. Cl. CPC G02B 21/0076; G02B 21/008; H04N 5/2256

(57) ABSTRACT

A microscope system includes: a light source configured to emit first excitation light for causing a fluorescent substance of a biological sample stained with the fluorescent substance to emit light; an objective lens configured to condense the first excitation light to the biological sample; a scanning mechanism configured to change an orientation of the first excitation light from the light source such that the first excitation light condensed by the objective lens scans the biological sample; a photodetector configured to input a first fluorescence that is generated from the biological sample by the first excitation light condensed to the biological sample, and to convert the first fluorescence into an electrical signal; and a macro imaging unit configured to apply second excitation light to the biological sample, and to capture an image of a second fluorescence by macro imaging, the second fluorescence being generated from the biological sample.

### CROSS REFERENCE TO RELATED APPLICATIONS

This application claims the benefit of Japanese Priority Patent Application JP 2013-272795 filed Dec. 27, 2013, the entire contents of which are incorporated herein by reference.

### BACKGROUND

The present disclosure relates to a microscope system in which a laser microscope that scans a sample with laser light and acquires an image of the sample, and the like are used, and to a processing method for the microscope system.

The following laser microscopes are widely known.

Laser light is condensed as excitation light to a sample with a fluorescent label from a light source through an objective lens. At that time, the orientation of the excitation light output from the light source is changed by a galvanometer mirror, and thus an application position of the excitation light is moved on the sample and the sample is scanned. The excitation light causes a fluorescent material of the sample to emit fluorescence light. The fluorescence passes through a pinhole formed in a confocal diaphragm, a barrier filter, and the like to be input to a photodetector. The photodetector converts the detected fluorescence into an electrical signal and transmits it to a control device. The control device generates an image of the sample based on the electrical signal supplied from the photodetector and displays the image on a display device (see Japanese Patent Application Laid-open No. 2013-003338).

### SUMMARY

The field of an objective lens in the laser microscope is about 3 to 4 mm wide even with a low-power lens of four-fold magnification, for example. In contrast, a glass slide generally used for a sample has a long side of 80 mm. An observation window of a glass bottom dish used as a container for observing cultured cells has a diameter size of 27 mm. So, in order to grasp the position of a cell as an observation target from an image observed through the objective lens, it is necessary to repeatedly move the stage on which the sample is placed, in a plane orthogonal to the optical axis of the objective lens and shift the field of the objective lens. This takes a lot of time.

This is part of the problems to be solved by the present disclosure. In addition, in the microscope system such as the laser microscope, there is a demand for a technique for improving performance in various points of view.

In view of the circumstances as described above, it is desirable to provide a microscope system of excellent performance.

According to an embodiment of the present disclosure, there is provided a microscope system including a light source, an objective lens, a scanning mechanism, a photodetector, and a macro imaging unit. The light source is configured to emit first excitation light for causing a fluorescent substance of a biological sample to emit light, the biological sample being stained with the fluorescent substance. The objective lens is configured to condense the first excitation light to the biological sample. The scanning mechanism is configured to change an orientation of the first excitation light from the light source such that the first excitation light condensed by the objective lens scans the biological sample. The photodetector is configured to input a first fluorescence that is generated from the biological sample by the first excitation light condensed to the biological sample, and to convert the first fluorescence into an electrical signal. The macro imaging unit is configured to apply second excitation light to the biological sample, and to capture an image of a second fluorescence by macro imaging, the second fluorescence being generated from the biological sample.

The biological sample may include at least one cultured cell and a container that accommodates the at least one cultured cell. The microscope system may further include a controller configured to calculate a position of at least a part of the at least one cultured cell from the image captured by the macro imaging, and to control a relative positional relationship between the biological sample and the objective lens such that a cultured cell selected as a target of an observation using the objective lens from the at least the part of the at least one cultured cell falls within a field of the objective lens in the observation using the objective lens.

The controller may be configured to perform distortion correction on the image captured by the macro imaging and to calculate a position of the at least the part of the at least one cultured cell from the image obtained after the distortion correction.

The macro imaging unit may be configured to capture a fluorescence image of the whole of the biological sample.

The macro imaging unit may include an imaging device and a macro lens that forms the fluorescence image of the whole of the biological sample onto the imaging device, and the macro lens may have a depth of focus that is larger than that of at least the objective lens.

The biological sample may include at least one biological tissue slice and a container that accommodates the at least one biological tissue slice. The microscope system according to the embodiment of the present disclosure may further include a controller configured to calculate a position of at least a part of the at least one biological tissue slice from the image captured by the macro imaging, and to control a relative positional relationship between the biological sample and the objective lens such that a part of interest selected as a target of an observation using the objective lens from the at least one biological tissue slice falls within a field of the objective lens in the observation using the objective lens.

According to another embodiment of the present disclosure, there is provided a control method for a microscope system, the control method including: providing a macro imaging unit to a laser microscope, the laser microscope being configured to observe a fluorescent image of a biological sample stained with a fluorescent substance, the macro imaging unit being configured to capture a fluorescence macro image of the biological sample; calculating, by a controller, a position of at least a part of at least one cultured cell from an image captured by macro imaging in the macro imaging unit; and controlling, by the controller, a relative positional relationship between the biological sample and the objective lens such that a cultured cell selected as a target of an observation using the objective lens from the at least the part of the at least one cultured cell falls within a field of the objective lens in the observation using the objective lens.

As described above, according to the present disclosure, it is possible to provide a microscope system of excellent performance.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a configuration of a microscope system according to a first embodiment of the present disclosure;

FIG. 2 is a flowchart of operations from the setting of a sample to an observation of cells in a typical microscope system;

FIG. 3 is a diagram showing an environment in which cells are two-dimensionally cultured by using a glass bottom dish;

FIG. 4 is a diagram showing an environment in which cells are three-dimensionally cultured by using a glass bottom dish;

FIG. 5 is a flowchart of operations from the setting of a sample of a cultured cell to an observation of a cell of interest in the microscope system of this embodiment;

FIG. 6 is a conceptual diagram of a fluorescence macro image of a sample, which is captured by a macro imaging unit and subjected to distortion correction;

FIG. 7 is a diagram showing a positional relationship between a cell of interest and the field of an objective lens;

FIG. 8 is a flowchart of operations from the setting of a sample of a biological tissue slice to an observation of a part of interest in the microscope system of this embodiment;

FIG. 9 is a diagram showing a configuration of a fluorescence excitation illumination as a first modification;

FIG. 10 is a diagram showing a configuration of a fluorescence excitation illumination as a second modification; and

FIG. 11 is a diagram showing a positional relationship between a plurality of biological tissues in a sample holder and the field of the objective lens.

### DETAILED DESCRIPTION OF EMBODIMENTS

Hereinafter, an embodiment of the present disclosure will be described with reference to the drawings.

### First Embodiment

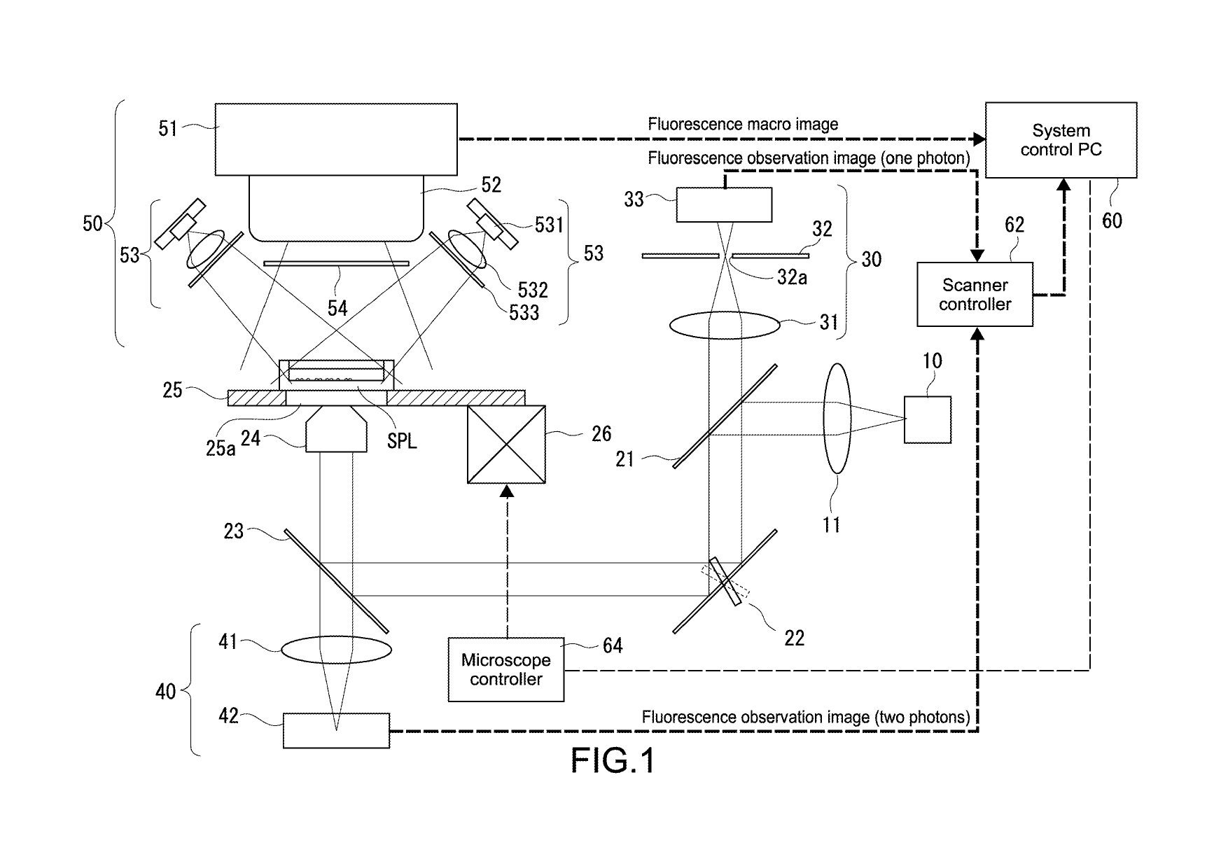

FIG. 1 is a diagram showing a configuration of a microscope system 100 according to a first embodiment of the present disclosure.

In this embodiment, the microscope system 100 in which a laser microscope is used will be described.

As shown in FIG. 1, the microscope system 100 includes a laser light source 10, a first dichroic mirror 21, a galvanometer mirror 22, a second dichroic mirror 23, an objective lens 24, a stage 25, a one-photon excitation imaging unit 30, a two-photon excitation imaging unit 40, a macro imaging unit 50, a system control PC (Personal Computer) 60, a scanner controller 62, and a microscope controller 64.

The laser light source 10 (light source) outputs laser light (hereinafter, referred to as “excitation light”) for exciting a fluorescent substance of a sample SPL. The laser light source 10 can selectively generate one-photon excitation light and two-photon excitation light that have different wavelengths. The one-photon excitation light and the two-photon excitation light are collectively referred to as “excitation light”.

The excitation light output from the laser light source 10 is changed into parallel light by a collimator lens 11 and input to the first dichroic mirror 21.

The first dichroic mirror 21 reflects the excitation light input by the collimator lens 11 and then inputs the light to the galvanometer mirror 22.

The galvanometer mirror 22 (scanning mechanism) includes one or more mirrors that are driven independently. The galvanometer mirror 22 changes the orientation of the excitation light, which is input by the collimator lens 11, such that the focus of the excitation light two-dimensionally scans the sample SPL placed on the stage 25.

The excitation light output from the galvanometer mirror 22 is input to the second dichroic mirror 23.

The second dichroic mirror 23 reflects the excitation light (one-photon excitation light or two-photon excitation light), which is input by the galvanometer mirror 22, and inputs the light to the objective lens 24.

The objective lens 24 condenses the excitation light (one-photon excitation light or two-photon excitation light), which is input by the second dichroic mirror 23, to the sample SPL on the stage 25. By reception of the excitation light, a fluorescence by one-photon excitation or a fluorescence by two-photon excitation, which is emitted from the fluorescent material of the sample SPL passes through the objective lens 24 and is input to the second dichroic mirror 23.

The objective lens 24 is disposed below the stage 25. An opening 25a for causing light to pass therethrough is provided at a part of the stage 25, at which the sample SPL is placed. Specifically, the excitation light from the objective lens 24 is applied to the sample SPL through the opening 25a of the stage 25. By reception of the excitation light, the fluorescence generated by the fluorescent substance of the sample SPL is also input to the objective lens 24 through the opening 25a of the stage 25.

When the fluorescence that is input through the objective lens 24 is the fluorescence by two-photon excitation, the second dichroic mirror 23 transmits and inputs fluorescent components by two-photon excitation to the two-photon excitation imaging unit 40.

Additionally, when the fluorescence that is input through the objective lens 24 is the fluorescence by one-photon excitation, the second dichroic mirror 23 reflects and inputs wavelength components of the fluorescence by one-photon excitation to the galvanometer mirror 22.

The galvanometer mirror 22 inputs the fluorescence by one-photon excitation, which is input by the second dichroic mirror 23, to the first dichroic mirror 21.

The first dichroic mirror 21 causes the fluorescence by one-photon excitation, which is input by the galvanometer mirror 22, to pass therethrough and inputs the fluorescence to the one-photon excitation imaging unit 30.

The one-photon excitation imaging unit 30 includes a first condenser lens 31, a pinhole 32, and a first photodetector 33.

The first condenser lens 31 condenses and inputs the fluorescence by one-photon excitation, which is input by the first dichroic mirror 21, to the pinhole 32.

The pinhole 32 includes a circular opening 32a at a position conjugate to a focal position of the objective lens 24 (i.e., image position). The pinhole 32 causes only a fluorescence, which passes through the opening 32a, to reach a light receiving surface of the first photodetector 33, from the fluorescence by one-photon excitation input by the first condenser lens 31.

The first photodetector 33 (photodetector) converts the fluorescence, which is input through the pinhole 32, into an electrical signal corresponding to a light intensity. The first photodetector 33 is formed of a PMT (Photo Multiplier Tube), for example.

The two-photon excitation imaging unit 40 includes a second condenser lens 41 and a second photodetector 42.

The second condenser lens 41 condenses and inputs the fluorescence by two-photon excitation, which is input by the second dichroic mirror 23, to a light receiving surface of the second photodetector 42. The fluorescent material is excited by the two-photon excitation light only at the vicinity of the focal point, and thus it is unnecessary to provide a pinhole, unlike the one-photon excitation imaging unit 30.

The second photodetector 42 (photodetector) converts the fluorescence by two-photon excitation, which is applied through the second condenser lens 41, into an electrical signal corresponding to an intensity of the fluorescence. The second photodetector 42 is formed of a PMT (Photo Multiplier Tube), for example, as in the first photodetector 33.

The stage 25 is formed to be movable in XY directions orthogonal to an optical axis of the objective lens 24 and in a Z direction along the optical axis. The sample SPL is placed on the stage 25. The sample SPL is, for example, a glass bottom dish that is a container for accommodating cultured cells, a preparation for holding a biological tissue slice between a glass slide and a cover slip, and the like. The cultured cells or biological tissue slice in the sample SPL is stained with a substance having fluorescence property. Such a sample SPL is also referred to as a fluorescent specimen.

[Configuration of Macro Imaging Unit 50]

The macro imaging unit 50 is a system for capturing an overall fluorescent image of the sample SPL.

The macro imaging unit 50 is disposed above the stage 25. Specifically, the macro imaging unit 50 is disposed on the opposing side of the surface of the stage 25, on which the sample SPL is placed.

The macro imaging unit 50 includes an imaging device 51, a macro lens 52, a plurality of fluorescence excitation illuminations 53, and a fluorescence filter 54.

The imaging device 51 is a relatively large imaging device for macro imaging. For example, the imaging device 51 is an imaging device of APS (Advanced Photo System) size, full size, or the like. For example, a CCD (Charge Coupled Device) or CMOS (Complementary Metal Oxide Semiconductor) image sensor is used as the imaging device 51. The imaging device 51 is a color imager including a photoelectric conversion element that receives light of RGB (Red, Green, and Blue) for each color and converts the light into electrical signals and that obtains a color image from the input light.

The macro lens 52 is an optical lens for macro imaging. In this embodiment, a macro lens 52 having a large depth of focus is adopted.

Each of the fluorescence excitation illuminations 53 applies light for exciting the fluorescent substance of the sample SPL to the entire surface of the sample SPL. The fluorescence excitation illuminations 53 are disposed so as to uniformly illuminate the entire area of the sample SPL, for example, such that the excitation light can be applied to the sample SPL from four directions. More specifically, the fluorescence excitation illuminations 53 may be formed of four illuminations.

The fluorescence excitation illumination 53 is formed of an excitation light source 531, a condenser lens 532, and an excitation filter 533, for example. As the excitation light source 531, for example, an LED (Light Emitting Diode) having a wavelength of 365 nm can be used.

The fluorescence filter 54 is disposed between the macro lens 52 and the sample SPL on the stage 25. The fluorescence filter 54 prevents the excitation light from entering the macro lens 52. Specifically, the fluorescence filter 54 is a unit for selectively guiding a fluorescence to the macro lens 52, the fluorescence being emitted from the fluorescent substance of the sample SPL by reception of the excitation light.

Hereinabove, the macro imaging unit 50 has been described.

The microscope controller 64 controls a stage drive unit 34 based on an instruction from the system control PC 60 (controller). The stage drive unit 34 moves the stage 25 in three XYZ-axis directions. Here, the Z-axis direction is a direction along the optical axis of the objective lens 24, and the X- and Y-axis directions are orthogonal to the Z axis and orthogonal to each other.

The scanner controller 62 performs control of the galvanometer mirror 22, control of the photodetectors 33 and 42, control of the laser light source 10, and the like.

The scanner controller 62 performs analog-to-digital conversion (A/D conversion) of signals that are output from the first photodetector 33 of the one-photon excitation imaging unit 30 and the second photodetector 42 of the two-photon excitation imaging unit 40, processing of generating image data of each sample SPL based on the A/D-converted digital signals, and the like.

The system control PC 60 includes a hardware configuration of a typical computer. Specifically, the system control PC 60 includes a memory, a CPU (Central Processing Unit), a data storage device, a system bus, and the like.

The data storage device stores an OS (Operating System), an application program for controlling the microscope system 100, an application program for image processing, and the like. Further, the data storage device holds image data transferred from the scanner controller 62, results of image processing executed by the CPU of the system control PC 60, and the like.

As the data storage device, an HDD (Hard Disk Drive) is mainly used, but an optical disc drive, an SSD (Solid State Drive), and other kinds of storages may be used.

The CPU controls the microscope system 100 according to the application program and the OS stored in the memory. For example, the CPU supplies information on the movement of the stage 25 to the microscope controller 64.

[Operation of Typical Microscope System]

Next, description will be given on operations from the setting of a sample to an observation of cells in a typical microscope system, which is compared with the microscope system 100 of this embodiment.

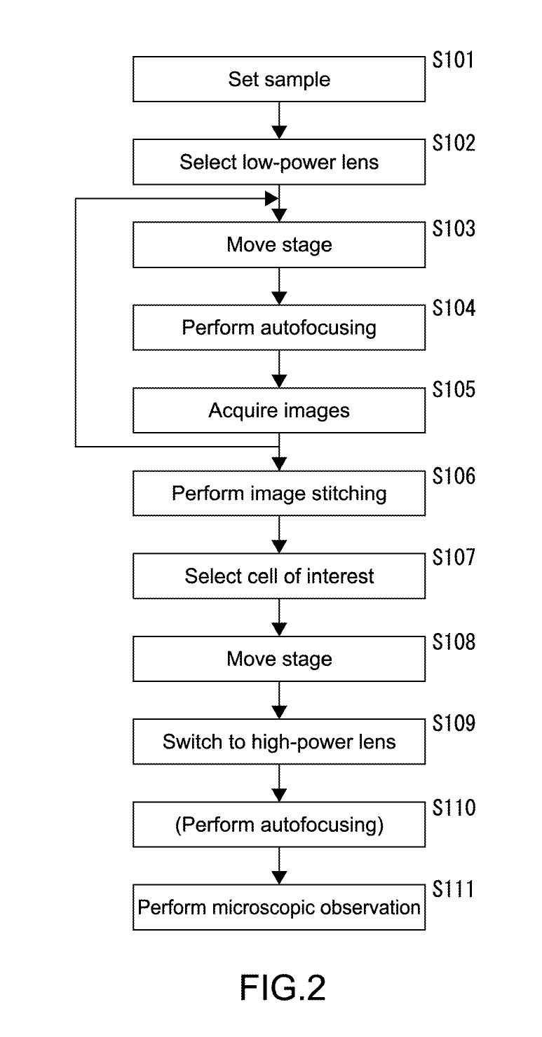

FIG. 2 is a flowchart of operations from the setting of a sample to an observation of a cell of interest in such a typical microscope system.

Here, the “cell of interest” refers to a cell as an observation target in the process of observation.

In the typical microscope system, first, a fluorescence macro image of a sample is acquired by an observation optical system using an objective lens as follows.

1. A sample is set on a stage (Step S101).

2. An objective lens is switched to a low-power lens (Step S102).

3. Here, a field size that can be observed using the objective lens has a diameter of about 17 mm in the case of using an objective lens of 1.25-fold magnification. In contrast, for example, a glass bottom dish generally used for observing a cultured cell has a hole diameter of 27 mm. So, under the condition, it is difficult to capture the entire image of the sample within the hole of the glass bottom dish by one imaging. For that reason, imaging is repeated while the stage is moved to change the field of the objective lens (Step S103).

4. Autofocusing is performed in order that the objective lens is in focus on the sample (Step S104).

5. Imaging is performed and image data of an area (hereinafter, referred to as “small area”) corresponding to the field of the objective lens in the sample is acquired (Step S105).

The loop from the movement of the stage in Step S103 to the acquisition of the image data of the small area in Step S105 is repeated until a plurality of image data items of the sample, which correspond to the entire area, for example, are acquired.

6. After the plurality of image data items of the sample, which correspond to the entire area, for example, are acquired, stitching processing of two-dimensionally connecting the image data items of the respective small areas to one another and creating image data on a sample basis is performed (Step S106).

7. Processing of selecting a cell of interest on the image data on the sample basis, which is acquired by the stitching processing, is performed (Step S107).

8. A position of the selected cell of interest is calculated based on the information on the movement of the stage when an image of a small area including the cell of interest is captured. Based on the positional information on the cell of interest, the stage is moved such that the cell of interest falls in an area observed using the objective lens (Step S108).

9. The objective lens is switched from a low-power lens for fluorescence macro imaging to a high-power lens for observation (Step S109).

10. Autofocusing is performed in order that a high-power objective lens is in focus on the cell of interest (Step S110). In the case where z-stack imaging to capture a plurality of images different in focal position is performed by moving the focal position of the objective lens by a predetermined distance and performing imaging in each case, the autofocusing in Step S110 is skipped.

11. Microscopic observation or microscopic imaging is performed (Step S111).

Hereinabove, the operations from the setting of a sample to the observation of a cell of interest in the typical microscope system have been described.

In the typical microscope system described above, many steps are performed from the setting of a sample to the acquisition of image data with which a cell of interest can be observed. Specifically, the size of the range whose image can be captured using the objective lens is only about 3 to 4 mm even with an objective lens of four-fold magnification. A glass slide used in the sample SPL has a long side of 80 mm. An observation window of a glass bottom dish as a container used for the observation of a cultured cell has a diameter size of 27 mm. So, in order to grasp the position of a cell as an observation target in an image observed through the objective lens, it is necessary to repeatedly move the stage on which the sample is placed, in a plane orthogonal to the optical axis of the objective lens and shift the field of the objective lens. This takes a lot of time.

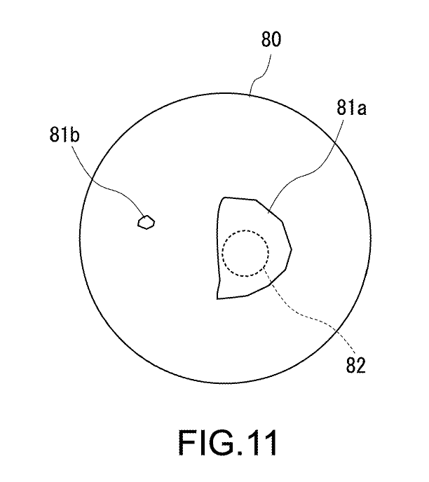

Further, in the case where the observation target is relatively large like a biological tissue slice, an observation is performed while the stage is moved along the outer shape of the biological tissue slice. However, for example, as shown in FIG. 11, in the case where a plurality of biological tissues 81a and 81b in a sample holder 80 are present apart from each other in a plane orthogonal to the optical axis of the objective lens and in the case where a distance between the plurality of biological tissues 81a and 81b is larger than a filed 82 of the objective lens, during observation of one biological tissue 81a, the other biological tissue 81b is difficult to appear in the filed 82. So, there is a possibility that the other biological tissue 81b is overlooked. Further, even when the presence of the other biological tissue 81b is known, it takes long time to find the other biological tissue 81b because the filed 82 of the objective lens is small.

Additionally, it also takes long time to perform a calculation for the stitching processing of two-dimensionally connecting image data items of a plurality of small areas captured by using the objective lens.

Besides, in the typical microscope system described above, it is difficult to obtain an excellent macro image of a cell in an environment in which cells are three-dimensionally cultured by using a glass bottom dish. The reason will be described below.

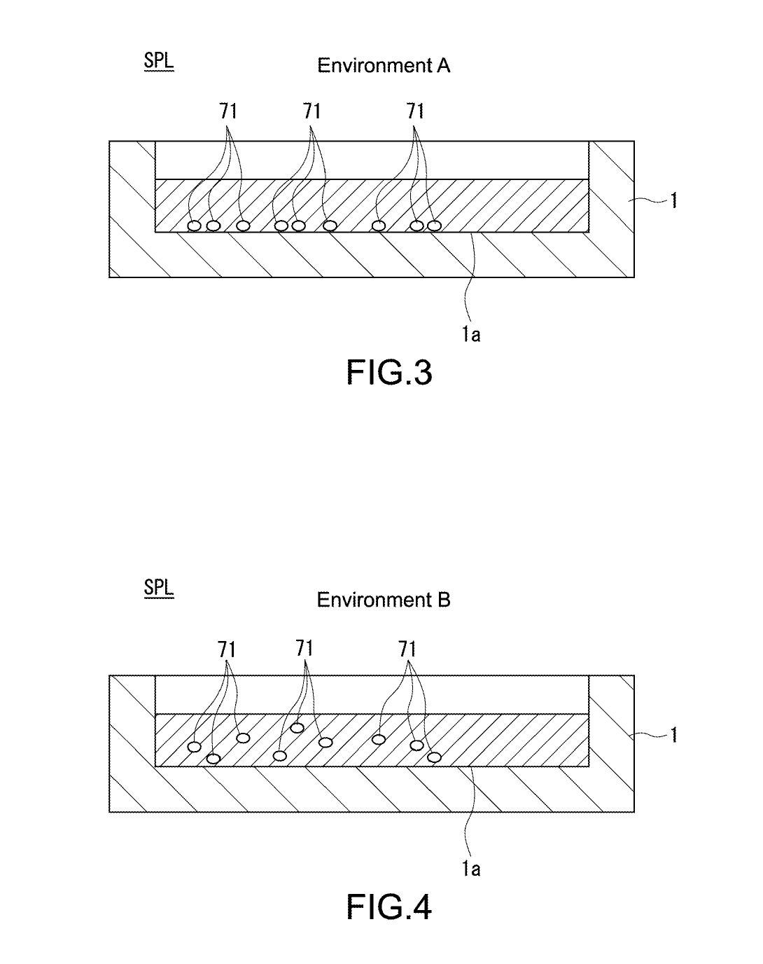

FIG. 3 is a diagram showing an environment A in which cells 71 are two-dimensionally cultured by using a glass bottom dish.

As shown in FIG. 3, in the environment A in which cells 71 are two-dimensionally cultured by using a glass bottom dish 1, most cells 71 are present in a state of being in contact with a bottom surface 1a of the glass bottom dish 1. So, an image obtained by connecting the images by stitching, which are captured with the focal position of the lower-power objective lens being in focus on the vicinity of the bottom surface 1a of the glass bottom dish 1, suffices in order to specify the positions of the cells 71.

However, as shown in FIG. 4, in an environment B in which cells 71 are three-dimensionally cultured by using the glass bottom dish 1, the cultured cells 71 are present not only in the vicinity of the bottom surface 1a of the glass bottom dish 1 and but also at various height positions from the bottom surface la.

For that reason, due to a focus shift, there occurs a part where images of the cells 71a are captured in a blurred state and it is difficult to excellently specify the positions of the cells 71. Specifically, the depth of focus in the case of using an objective lens having a 1.25-fold magnification and a numerical aperture NA of 0.04 is about 300 μm. The thickness of a space in which the cells 71 are cultured in the glass bottom dish 1 is about 1000 μm, and thus the depth of focus of the objective lens described above is unsufficient.

Moreover, as described in documents (Moya et al., Stem Cell Research & Therapy 2013, 4 (Suppl 1):N http://stemcellres.com/content/4/S1/N, and Hsu, Y. -H#, M. Moya#, C. C. W. Hughes, S. C. George*, A. P. Lee*, A microfluidic platform for generating large-scale nearly identical human microphysiological system arrays, Lab Chip, 13 (15), 2990-2998, 2013), in such three-dimensional culture environments, there is one environment formed of a chip having relatively the same size as the glass slide and a plurality of culture chambers formed in the chip. When a method according to the typical microscope system described above is adopted for such a three-dimensional culture environment, it takes measurable time to perform imaging.

[Operation of Microscope System 100 of This Embodiment]

Next, description will be given on operations from the setting of a sample to an observation of cell of interest in the microscope system 100 of this embodiment.

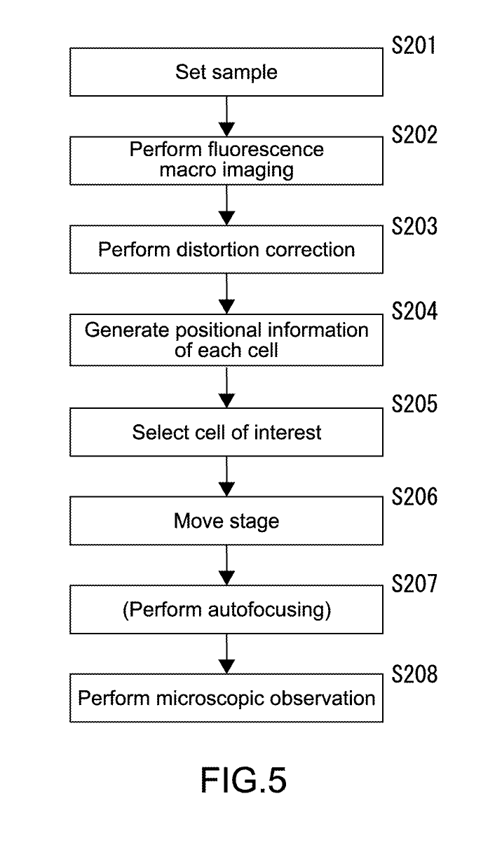

FIG. 5 is a flowchart of operations from the setting of a sample to an observation of a cell of interest in the microscope system 100 of this embodiment.

1. A sample SPL is set on the stage 25 (Step S201).

2. In the macro imaging unit 50, excitation light is applied to the entire area of the sample SPL from the fluorescence excitation illuminations 53, and the imaging device 51 captures an image of a fluorescence that is emitted from the sample SPL through the fluorescence filter 54 and the macro lens 52 (Step S202). Specifically, a fluorescence macro image of the entire area of the sample SPL is acquired by one imaging. So, regarding the movement of the stage 25, the stage 25 only needs to be moved before imaging, for example, such that the center of the XY plane of the sample SPL is caused to match the optical axis of the macro imaging unit 50.

The macro imaging unit 50 A/D-converts the output of the imaging device 51, changes it into an image, and supplies image data to the system control PC 60.

3. In general, an image captured using the macro lens is distorted somewhat (image with distortion). In this regard, in the system control PC 60, the CPU performs distortion correction on the fluorescence macro image according to the application program (Step S203).

The distortion correction is performed as follows.

Previously, an image of a lattice-shaped pattern is captured by the macro imaging unit 50. In the system control PC 60, the CPU evaluates a distortion based on image data of the lattice-shaped pattern that is supplied from the macro imaging unit 50 and calculates a distortion correction value for cancelling this distortion. The CPU corrects the fluorescence macro image of the sample SPL, which is captured by using the macro imaging unit 50, by using the distortion correction value described above.

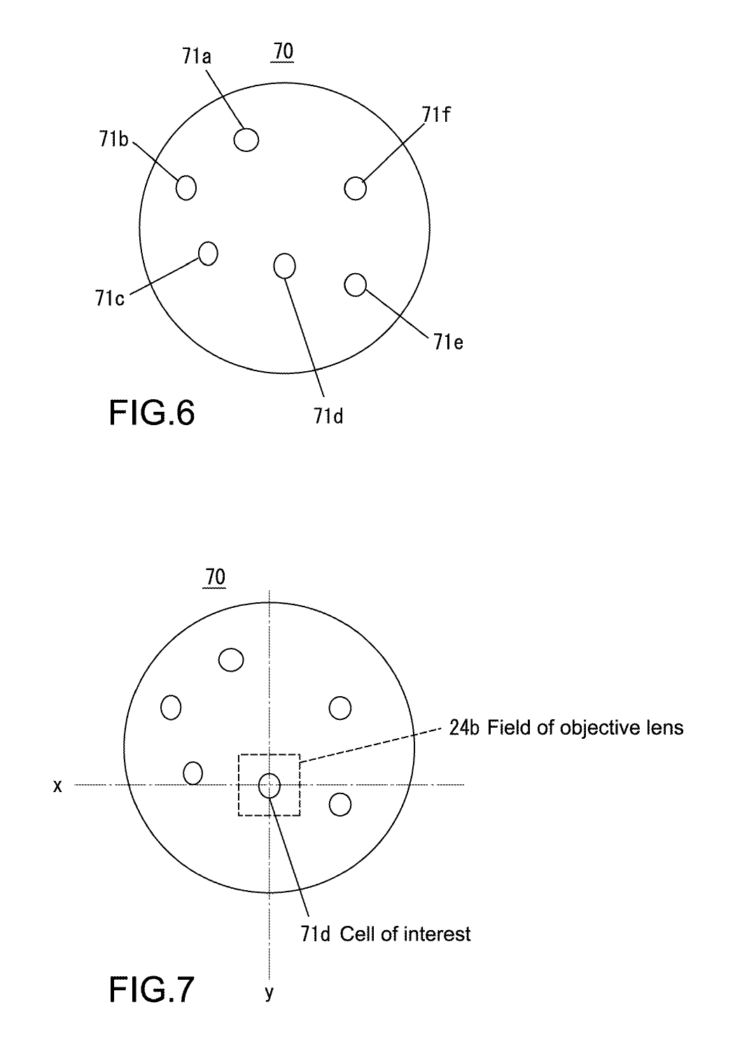

FIG. 6 is a conceptual diagram of a fluorescence macro image 70 of the sample SPL, which is captured by the macro imaging unit 50. The fluorescence macro image 70 includes fluorescent images 71a, 71b, 71c, 71d, 71e, and 71f of a plurality of cells.

4. Next, in the system control PC 60, the CPU calculates a position of a fluorescent image of at least one cell in the fluorescence macro image that has been subjected to the distortion correction, and holds that positional information in the memory or the data storage device (Step S204).

5. In the system control PC 60, the CPU or an observer selects a fluorescent image of a cell of interest from the fluorescent image of the at least one cell included in the fluorescence macro image (Step S205).

For example, in the fluorescence macro image 70 of FIG. 6, it is assumed that a cell of the fluorescent image 71d is selected as a cell of interest.

6. In the system control PC 60, the CPU refers to the positional information of the selected cell of interest from the memory or the data storage device. Based on the positional information, for example as shown in FIG. 7, the CPU outputs to the microscope controller 64 an instruction to move the stage 25 such that a cell corresponding to the fluorescent image 71d of a cell of interest falls within a field 24b of the objective lens 24 (Step S206).

7. Next, in the system control PC 60, the CPU executes autofocusing so that the focus of the objective lens 24 is adjusted to the selected cell of interest (Step S207). In the case where z-stack imaging to capture a plurality of images different in focal position is performed by moving the focal position of the objective lens 24 by a predetermined distance and performing imaging in each case, the autofocusing in Step S207 is skipped.

Examples of the autofocusing method includes:

a. a method of searching for a focal position by changing a focal position at, for example, intervals smaller than the depth of focus and capturing images in each case to analyze the captured images; and

b. a method of, while moving the focal position of the objective lens in an optical axis direction of the objective lens and a direction orthogonal to the optical axis, generating a long-time exposure image of an area by successively exposing the imaging device and performing an frequency analysis of the long-time exposure image, to calculate a focal position of a fluorescent label by using results of the analysis.

8. Subsequently, a microscopic observation or a microscopic imaging is performed (Step S208).

In the above description, the CPU of the system control PC 60 performs processing by receiving the fluorescence macro image from the macro imaging unit 50. However, instead of the CPU of the system control PC 60, the scanner controller 62 or the microscope controller 64 may perform those processing control.

As can be understood from the above description on the operations, according to the microscope system 100 of this embodiment, a fluorescence macro image on a sample basis can be obtained by one imaging.

For example, in the case where the macro imaging unit 50 uses, as the imaging device 51, an imaging device of APS (Advanced Photo System) size or full size, such as an imaging device having a short side of 1,800 pixels, an image of the range of a diameter of 27 mm, which is a diameter size of the observation window of the glass bottom dish, can be captured at a resolution of 15 μm or less per pixel. With such a level of resolution, a fluorescence macro image in which each cell can be recognized sufficiently can be obtained.

In the case where the entire image of a glass slide having a long side of 80 mm is captured by the macro imaging unit 50, for example, an imaging device of full size (24 mm by 36 mm) having 24 megapixels (4,000 by 6,000) each of which is 6 μm-square is used for imaging, to thus obtain a fluorescence macro image in which each cell can be recognized.

Further, according to the microscope system 100 of this embodiment, it is unnecessary to repeatedly move the stage 25 and perform the stitching processing. This can significantly reduce time from the setting of the sample SPL on the stage 25 to the observation of the cell of interest.

Furthermore, according to the microscope system 100 of this embodiment, a lens of a large depth of focus is selected as the macro lens 52 of the macro imaging unit 50. This can provide a fluorescence macro image in which each cell can be recognized in an environment in which cells are three-dimensionally cultured by using the glass bottom dish 1 (in the environment B of FIG. 4). So, it is possible to reduce the occurrence of oversight of the cell of interest. It is necessary that the depth of focus of the macro lens 52 be larger than at least that of the objective lens 24.

Moreover, the microscope system 100 of this embodiment allows a fluorescence macro image on a sample basis to be captured at high speed. Thus, it is effective in a purpose in which a high-definition image data is unnecessary, for example, in the case where behaviors of cells cultured for a long time (number of cells, density, and the like) are intended to be observed.

Hereinabove, the operations assuming that the observation target is each cell have been described.

Operations in the case where the observation target is a biological tissue slice are as follows.

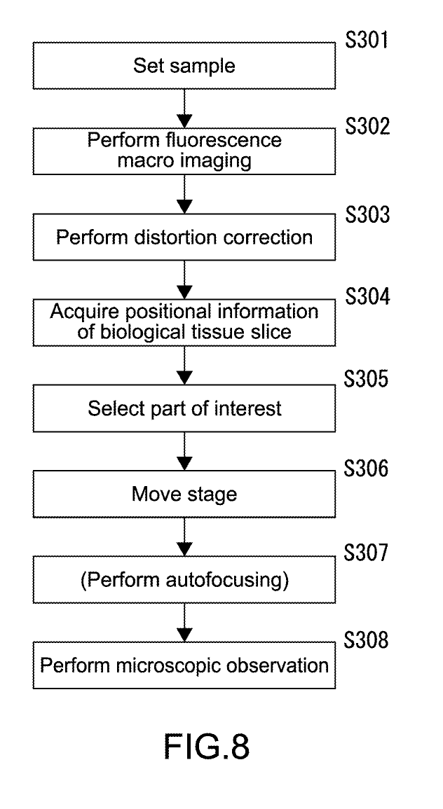

In the case where a fluorescence macro image includes a fluorescent image of a biological tissue slice in a wide range, in the system control PC 60, as shown in FIG. 8 for example, the CPU detects the range in which the biological tissue slice is present in the fluorescence macro image and stores positional information of the range in the memory or the data storage device (Step S304).

Subsequently, in the system control PC 60, the CPU or an observer selects a part of interest in an image of the biological tissue slice (Step S305). Based on the positional information of the selected part of interest, the CPU outputs, to the microscope controller 64, an instruction to move the stage 25 such that the part of interest falls within the field 24b of the objective lens 24 (Step S306).

It should be noted that operations before and after the operations described above are the same as those in Steps S201, S202, S203, S207, and S208 in the flowchart of FIG. 5, and thus overlapping description will be omitted.

<Modification 1>

Next, description will be given on a modification of the fluorescence excitation illumination 53 of the macro imaging unit 50.

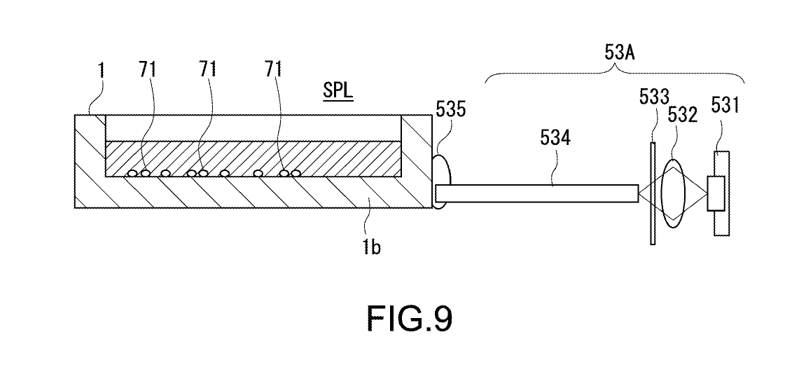

FIG. 9 is a diagram showing a configuration of a fluorescence excitation illumination 53A as a first modification.

The fluorescence excitation illumination 53A includes an excitation light source 531, a condenser lens 532, an excitation filter 533, and an optical waveguide 534.

The optical waveguide 534 inputs excitation light that is condensed by the condenser lens 532 and passes through the excitation filter 533 from one end surface, and outputs the excitation light from the other end surface. The other end surface of the optical waveguide 534 is jointed to a side surface of the glass bottom dish 1, which corresponds to a height position of a bottom plate 1b with use of a joining material 535 such as contact grease. By the fluorescence excitation illumination 53A, particularly, the fluorescent material of the cells 71 that are present while being in contact with the bottom surface 1a of the glass bottom dish 1 is excited extremely effectively. So, it can be said that the fluorescence excitation illumination 53A is an effective fluorescence excitation illumination for an environment in which the cells 71 are two-dimensionally cultured by using the glass bottom dish 1 (environment A shown in FIG. 3).

<Modification 2>

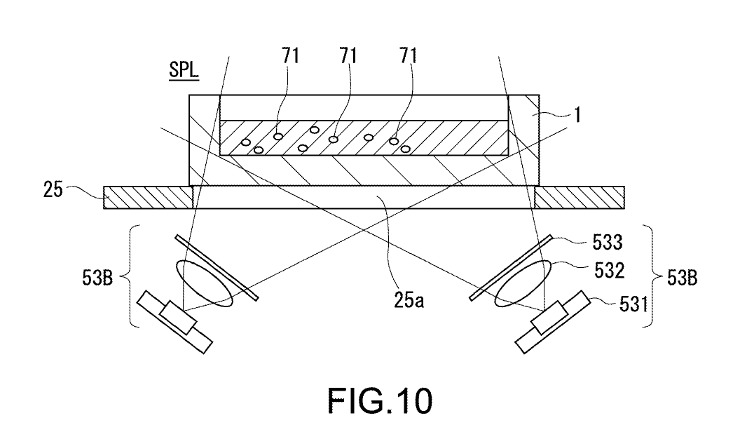

FIG. 10 is a diagram showing a configuration of a fluorescence excitation illumination 53B as a second modification.

The fluorescence excitation illumination 53B applies excitation light for macro imaging from the rear surface of the sample SPL, that is, from the bottom plate surface of the glass bottom dish 1 through the opening 25a of the stage 25. The fluorescence excitation illumination 53B is suitable for an environment in which the cells 71 are three-dimensionally cultured by using the glass bottom dish 1 (environment B shown in FIG. 4).

It should be noted that the present disclosure can have the following configurations.
(1) A microscope system, including:

a light source configured to emit first excitation light for causing a fluorescent substance of a biological sample to emit light, the biological sample being stained with the fluorescent substance;

an objective lens configured to condense the first excitation light to the biological sample;

a scanning mechanism configured to change an orientation of the first excitation light from the light source such that the first excitation light condensed by the objective lens scans the biological sample;

a photodetector configured
to input a first fluorescence that is generated from the biological sample by the first excitation light condensed to the biological sample, and
to convert the first fluorescence into an electrical signal; and

a macro imaging unit configured
to apply second excitation light to the biological sample, and
to capture an image of a second fluorescence by macro imaging, the second fluorescence being generated from the biological sample.
(2) The microscope system according to (1), in which

the biological sample includes at least one cultured cell and a container that accommodates the at least one cultured cell,

the microscope system further including a controller configured
to calculate a position of at least a part of the at least one cultured cell from the image captured by the macro imaging, and
to control a relative positional relationship between the biological sample and the objective lens such that a cultured cell selected as a target of an observation using the objective lens from the at least the part of the at least one cultured cell falls within a field of the objective lens in the observation using the objective lens.
(3) The microscope system according to any one of (1) and (2), in which

the controller is configured to perform distortion correction on the image captured by the macro imaging and to calculate a position of the at least the part of the at least one cultured cell from the image obtained after the distortion correction.
(4) The microscope system according to any one of (1) to (3), in which

the macro imaging unit is configured to capture a fluorescence image of the whole of the biological sample.
(5) The microscope system according to any one of (1) to (4), in which

the macro imaging unit includes an imaging device and a macro lens that forms the fluorescence image of the whole of the biological sample onto the imaging device, and

the macro lens has a depth of focus that is larger than that of at least the objective lens.
(6) The microscope system according to any one of (1) to (5), in which

the biological sample includes at least one biological tissue slice and a container that accommodates the at least one biological tissue slice,

the microscope system further including a controller configured
to calculate a position of at least a part of the at least one biological tissue slice from the image captured by the macro imaging, and
to control a relative positional relationship between the biological sample and the objective lens such that a part of interest selected as a target of an observation using the objective lens from the at least the part of the at least one biological tissue slice falls within a field of the objective lens in the observation using the objective lens.

It should be understood by those skilled in the art that various modifications, combinations, sub-combinations and alterations may occur depending on design requirements and other factors insofar as they are within the scope of the appended claims or the equivalents thereof.

What is claimed is:

1. A microscope system, comprising:
a light source configured to emit first excitation light for causing a fluorescent substance of a biological sample to emit light, the biological sample being stained with the fluorescent substance;
an objective lens configured to condense the first excitation light to the biological sample;
a scanning mechanism configured to change an orientation of the first excitation light from the light source such that the first excitation light condensed by the objective lens scans the biological sample;
a photodetector configured
to input a first fluorescence that is generated from the biological sample by the first excitation light condensed to the biological sample, and
to convert the first fluorescence into an electrical signal; and
a macro imaging unit configured
to apply second excitation light to the biological sample, and
to capture an image of a second fluorescence by macro imaging, the second fluorescence being generated from the biological sample.

2. The microscope system according to claim 1, wherein
the biological sample includes at least one cultured cell and a container that accommodates the at least one cultured cell,
the microscope system further comprising a controller configured
to calculate a position of at least a part of the at least one cultured cell from the image captured by the macro imaging, and
to control a relative positional relationship between the biological sample and the objective lens such that a cultured cell selected as a target of an observation using the objective lens from the at least the part of the at least one cultured cell falls within a field of the objective lens in the observation using the objective lens.

3. The microscope system according to claim 2, wherein
the controller is configured to perform distortion correction on the image captured by the macro imaging and to calculate a position of the at least the part of the at least one cultured cell from the image obtained after the distortion correction.

4. The microscope system according to claim 1, wherein
the macro imaging unit is configured to capture a fluorescence image of the whole of the biological sample.

5. The microscope system according to claim 4, wherein
the macro imaging unit includes an imaging device and a macro lens that forms the fluorescence image of the whole of the biological sample onto the imaging device, and
the macro lens has a depth of focus that is larger than that of at least the objective lens.

6. The microscope system according to claim 1, wherein
the biological sample includes at least one biological tissue slice and a container that accommodates the at least one biological tissue slice,
the microscope system further comprising a controller configured
to calculate a position of at least a part of the at least one biological tissue slice from the image captured by the macro imaging, and
to control a relative positional relationship between the biological sample and the objective lens such that a part of interest selected as a target of an observation using the objective lens from the at least the part of the at least one biological tissue slice falls within a field of the objective lens in the observation using the objective lens.

7. A control method for a microscope system, the control method comprising:
providing a macro imaging unit to a laser microscope, the laser microscope being configured to observe a fluorescent image of a biological sample stained with a fluorescent substance, the macro imaging unit being configured to capture a fluorescence macro image of the biological sample;
calculating a position of at least a part of at least one cultured cell from an image captured by macro imaging in the macro imaging unit; and
controlling a relative positional relationship between the biological sample and the objective lens such that a cultured cell selected as a target of an observation using the objective lens from the at least the part of the at least one cultured cell falls within a field of the objective lens in the observation using the objective lens.
